(19) United States
(12) Patent Application Publication
(10) Pub. No.: US 2025/0350916 A1
(43) Pub. Date: Nov. 13, 2025

(54) APPROACH TO SELECTING A PREFERRED NETWORK USING MULTIPLE CONNECTIVITY CHIPSETS

(71) Applicant: Cypress Semiconductor Corporation, San Jose, CA (US)

(72) Inventors: George Koruthu, Bangalore (IN); Vinoth Sampath, Bangalore (IN); Mallikarjun Ramappa Nemagoudar, Belagavi (IN); Manish Bansal, Bangalore (IN)

(73) Assignee: Cypress Semiconductor Corporation, San Jose, CA (US)

(21) Appl. No.: 19/044,439

(22) Filed: Feb. 3, 2025

Related U.S. Application Data
(60) Provisional application No. 63/645,704, filed on May 10, 2024.

(51) Int. Cl. H04W 8/00; H04W 48/18; H04W 76/10

(52) U.S. Cl. CPC H04W 8/005; H04W 48/18; H04W 76/10

(57) ABSTRACT

Technologies related to network scanning are described. A first network scan is performed within a first frequency band. A network is selected based on the first network scan. Based on the selection of the network, a second network scan is performed within a second frequency band different from the first frequency band.

### CROSS-REFERENCE TO RELATED APPLICATIONS

This application claims benefit of U.S. Provisional Application No. 63/645,704, filed May 10, 2024, the contents of which are incorporated herein by reference in its entirety.

### BACKGROUND

In wireless environments, network scanning is used by client devices to detect and identify nearby available networks. Many networks support access points (APs) within multiple frequency bands, including the relatively new 6 GHz band.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a wireless device, according to one embodiment.

FIG. 2 is a graph illustrating an exemplary implementation of operations of the network scan logic, according to one embodiment.

FIG. 3 is a flowchart illustrating a method of initiating a connection to a network, according to one embodiment.

FIG. 4 illustrates a method 400 in accordance with one embodiment.

### DETAILED DESCRIPTION

Technologies related to scanning for known or priority networks are described. Network scanning may refer to background network scanning or preferred network scans (PNOs), which are processes in which a wireless local area network (WLAN)-enabled device searches for and selects a suitable or optimal network to connect with. PNOs often account for different criteria, such as signal strength, channel quality, and network load. In dual-band access points (APs) that operate on both the 2.4 GHz and 5 GHz bands, a network scan can find and select an AP of a network based on several factors. For example, the 5 GHz band provides higher speeds but has a shorter range, so devices closer to the AP might prefer the 5 GHz band for better performance, while devices farther away or obstructed by walls might choose the 2.4 GHz band. The same logic applies between the 6 GHz and 5 GHz bands, where the 6 GHz band provides higher speeds than the 5 GHz band but has a shorter range. Conventionally, during a network scan, a wireless device sequentially scans the 2.4 GHz, 5 GHZ, and sometimes 6 GHz (if applicable) bands to find and select a network. In the case of a triband AP (i.e., an AP operating on 2.4 GHz, 5 GHZ, and 6 GHz), networks found on the 2.4 GHz or 5 GHz bands may be found first and considered for connection before the wireless device scans for networks in the 6 GHz band. This may negatively affect the wireless device, as viable connections within 6 GHz may not be considered before initiating connection within either the 2.4 or 5 GHz bands.

Aspects and embodiments of the present disclosure address the above problem and others by providing network scanning operations that first search for a suitable network within the 2.4 GHz and/or 5 GHz bands, and after finding the suitable network, perform a network scan within the 6 GHz band to find a collocated AP (e.g., second AP) corresponding to the suitable network. In at least some embodiments, the collocated AP may be given preference over a collocated AP (e.g., first AP) that was found within one or more of the 2.4 GHz or 5 GHz bands. Aspects and embodiments may provide network scan operations that accounts for 6 GHz connections after finding a suitable network while scanning in the 2.4 GHz or 5 GHz frequency bands.

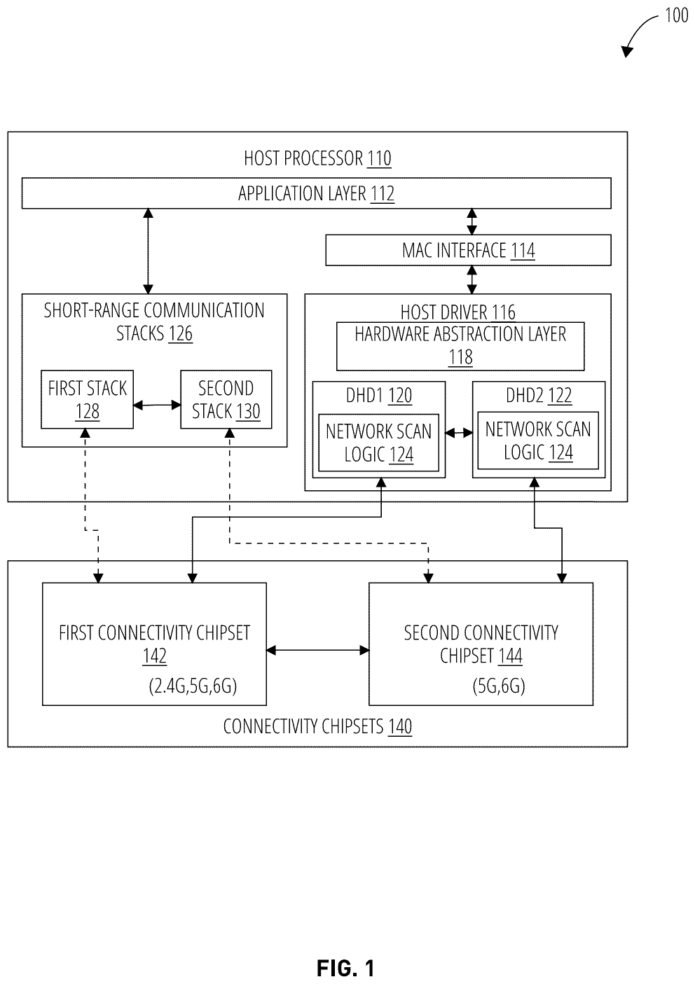

FIG. 1 illustrates a wireless device 100, according to one embodiment. The wireless device 100 may include a host processor 110 and one or more connectivity chipsets 140. In at least one embodiment, the wireless device 100 may be a client device that performs network scans. These network scans may include discovery, monitoring, and/or analysis of devices or activity across a network. Network scans may produce one or more metrics related to each identified network, as described in more detail below.

The host processor 110 may serve as the central control unit responsible for executing software applications and/or managing overall system operations. The host processor 110 may interface with various hardware components such as memory modules, input/output interfaces, and/or wireless communication subsystems. The host processor 110 may be implemented using a microprocessor, microcontroller, or digital signal processor (DSP). The host processor 110 may includes one or more processing cores, cache memory, and may support features like virtualization and security protocols. The host processor 110 may execute the operating system and higher-layer software stacks, handling tasks such as application execution, user interface management, and coordination with wireless transceivers for data transmission and reception.

In some embodiments, the host processor 110 may be integrated into a system-on-chip (SoC) design, combining the processor with other components like memory controllers, peripheral interfaces, and wireless modules onto a single integrated circuit to reduce size and power consumption. It may also incorporate specialized co-processors or accelerators, such as graphics processing units (GPUs) or neural processing units (NPUs). In some designs, the host processor 110 may support multi-threading and parallel processing capabilities. Alternatively, the host processor 110 may be optimized for low-power operation in energy-constrained devices, utilizing techniques like dynamic voltage and frequency scaling (DVFS) and power gating to conserve energy.

The host processor 110 may include an application layer 112. The application layer 112 may be responsible for executing user-level applications and providing a platform for application development and deployment. The application layer 112 may interface with the underlying operating system and hardware components to execute these user-level applications. The application layer 112 may include various software modules, libraries, and frameworks that facilitate tasks such as user interface rendering, data processing, and network communication. The application layer 112 may enable applications to perform specific functions by providing access to system resources, including memory, processing power, and input/output peripherals. In some embodiments, the application layer may support a multitasking environment, allowing multiple applications to run concurrently while efficiently managing system resources. It may incorporate security features such as authentication protocols, encryption algorithms, and sandboxing techniques to protect against unauthorized access and ensure data integrity.

The host processor 110 may include a media access control (MAC) interface 114 that communicates with the application layer 112. The MAC interface 114 may be responsible for providing the application layer 112 the ability to interact with a MAC functions of the wireless device 100. These MAC functions may correspond with MAC layer(s) of the connectivity chipsets 140, as described below. The MAC interface 114 may act as an intermediary between higher-level functions, such as those executed by the application layer 112, access to MAC layer services through the host driver 116 without handling low-level MAC or hardware specifics directly.

The host processor 110 may include a host driver 116. The host driver 116 may include a hardware abstraction layer 118, a first driver 120 and a second driver 122. The host driver 116 may facilitates communication between the MAC interface 114 and one or more connectivity chipsets 140. The host driver can include a hardware abstraction layer 118, a first driver 120 (also referred to as DHD1), and a second driver 122 (DHD2).

The hardware abstraction layer 118 can provide a standardized interface between the host processor's operating system and the underlying hardware components, abstracting hardware-specific details to enable seamless interaction. This hardware abstraction layer 118 can allow higher-level software to communicate with the hardware without needing to manage low-level hardware operations.

The first driver 120 (DHD1) and the second driver 122 (DHD2) may facilitate communication between the connectivity chipsets 140 and the hardware abstraction layer 118, which interfaces with the MAC interface 114 and other hardware components. The drivers 120, second driver 122 may be designed to handle wireless communication tasks, such as performing network scans, initiating connections, managing data packet transmission and reception, and/or processing standard wireless protocols. The drivers 120, 122 may each be responsible for establishing and maintaining basic network connectivity for different communication chipsets of the connectivity chipsets 140, configuring network parameters, and/or ensuring compliance with standard communication protocols.

Both drivers 120, 122 may communicate with the hardware abstraction layer 118 to interact with the underlying hardware without needing to manage hardware-specific operations directly. The hardware abstraction layer 118 provides a standardized interface that abstracts the complexities of the hardware components, enabling the drivers to execute hardware operations through high-level function calls or APIs. This layer translates driver commands into hardware-specific instructions and manages hardware resources, allowing for efficient and secure access to the MAC interface 114 and other components.

In some embodiments, the first and second drivers 120, 122 may operate independently or collaboratively, where first driver 120 handles the wireless communication functions of a first connectivity chipset 142 while the second driver 122 handles the wireless communication functions of a second connectivity chipset 144.

Communication between the drivers 120, 122 and the first and second connectivity chipsets 142, 144 may involve standardized protocols and interfaces, such as Peripheral Component Interconnect Express (PCIe), Universal Serial Bus (USB), secure digital input/output (SDIO), universal asynchronous receiver/transmitter (UART), pulse-code modulation (PCM), inter-IC (integrated circuit) sound (12S), custom inter-process communication mechanisms, or the like. The drivers 120, 122 may send commands and data to the hardware abstraction layer, which then interacts with the hardware components to execute the required operations.

One or more of the drivers 120, 122 may include network scan logic 124. In at least some embodiments, the drivers 120, 122 may be considered processing devices. The network scan logic 124 may include software, hardware, firmware, or a combination thereof that causes the drivers 120, 122 and/or connectivity chipsets 142, 144 to perform certain tasks, such as network scanning. According to embodiments, the network scan logic 124 may perform a preferred network offload (PNO) scan. In at least one embodiment, the network scan logic 124 may cause the wireless device 100 to initially perform a first network scan via the first connectivity chipset 142, and subsequently perform a second network scan via the second connectivity chipset 144 based on a result of the first network scan. In at least one embodiment, the first connectivity chipset 142 may be referred to as a primary or central (e.g., master) connectivity chipset, while the second connectivity chipset 144 may be referred to as a secondary or peripheral (e.g., slave) connectivity chipset.

According to embodiments, operations of the network scan logic 124 can discover networks by either actively sending out probe requests to solicit responses from nearby APs or passively listening for beacon frames that these nearby APs may regularly broadcast. The network scan logic 124 may evaluate each of these detected networks against a stored list of networks. The networks on this stored list may be networks that the wireless device 100 has connected to previously or may be other networks that are deemed high priority. The network scan logic 124 may test each detected network by assessing various metrics, such as: whether a respective detected network is on the stored list of networks, signal strength (sometimes measured by a received signal strength indicator (RSSI)), network security protocols, service set identifier (SSID), network congestion levels, latency, bandwidth availability, or historical connection performance (e.g., previous connection success rates or historical speeds experienced), or the like. The network scan logic 124 may rank the detected networks based on these various metrics, and the network scan logic 124 may select a network based on one or more of these metrics.

In some embodiments, the first network scan may allow the wireless device 100 to discover networks within one or more frequency bands. These frequency bands can include one or more of the 2.4 GHz or 5 GHz frequency bands. The second network scan may allow the wireless device 100 to discover networks within one or more frequency bands that are different than those scanned during the first network scan. These frequency bands can include the 5 GHz or 6 GHz frequency bands.

According to embodiments, the network scan logic 124 may select a first network based on (or during) the first network scan. This first network may provide the wireless device 100 a suitable connection, based on one or more of the various metrics provided above. These various metrics may be at least partially based on a first AP of the first network, which first AP may provide client devices with a connection to the first network within either the 2.4 GHz or the 5 GHz frequency band. Responsive to selecting the first network, the network scan logic 124 may perform the second network scan. The second network scan may include searching for a second AP corresponding to the first network. In at least one embodiment, the second AP may be collocated with the first AP. For example, the first AP may be a 2.4 GHz AP (i.e., an AP that operates within the 2.4 GHz band) or 5 GHZ AP (i.e., an AP that operates within the 5 GHz band) for the first network, and the second AP may be a 6 GHz AP (i.e., an AP that operates within a 6 GHz band) for the first network. In other words, the second AP may provide client devices with connections to the first network within a frequency band (e.g., second frequency band) that is higher than the frequency band (e.g., first frequency band) of the first AP.

The network scan logic 124 may select the first network using one or more of the above-mentioned metrics. In at least some embodiments, the network scan logic 124 may compare these metrics to respective threshold(s). Metrics satisfying these respective thresholds may indicate that the respective detected network is suitable for connection. In at least some cases, the network scan logic 124 may prioritize known networks (i.e., networks to which the wireless device 100 has previously connected) over unknown networks (i.e., networks to which the wireless device 100 has not previously connected). The network scan logic 124 may also prioritize the selection of a detected network based on RSSI values, security protocols, bandwidth availability, latency, or the like. In the event that no detected network has metrics that satisfy their respective thresholds, the network scan logic 124 may re-scan (i.e., perform subsequent network scan(s)) until a suitable network is detected. This suitable network may be a detected network that has one or more corresponding metrics that satisfy their respective thresholds. In some cases, this suitable network may be defined as a detected network to which the wireless device 100 can establish and maintain a connection.

While the network scan logic 124 herein is described as operations of the host driver 116 (or operations of one or more of the first driver 120 or second driver 122), some or all operations of the network scan logic 124 may be performed elsewhere within the wireless device 100. For example, the connectivity chipsets 140 may perform some or all of the operations of the network scan logic 124. The connectivity chipsets 140 may intercommunicate via global coexistence interface (GCI) bits that are designed to coordinate operations of the network scan logic 124 between the first connectivity chipset 142 and second connectivity chipset 144. In another embodiment, at least a portion of the network scan logic 124 may be performed by one or more of the hardware abstraction layer 118, MAC interface 114, or the application layer 112.

The wireless device 100 may also include short-range communication stacks 126. Stacks part of the short-range communication stacks 126 (e.g., first stack 128, second stack 130) may each be connected to one of the connectivity chipsets 140. The stacks 128, 130 may act as an interface between the connectivity chipsets 140 and the application layer 112. The stacks 128, 130 may be responsible for implementing protocol-specific operations required for short-range wireless communication technologies like Bluetooth®, including Bluetooth Low Energy (BLE®), as well as alternative protocols such as Near Field Communication (NFC) or Zigbee®.

In the case of the Bluetooth® protocol, the stacks 128, 130 may handle various layers of the Bluetooth® architecture, including device discovery, pairing, connection establishment, and data exchange. The stacks 128, 130 may manage functions like the Logical Link Control and Adaptation Protocol (L2CAP), the Attribute Protocol (ATT), and the Generic Attribute Profile (GATT), which are crucial for data transmission and device interoperability in BLE® communications. By abstracting the complex details of the Bluetooth® protocol, the stacks 128 130 may provide the application layer 112 with simplified interfaces and APIs.

Alternative short-range communication networks supported by the stacks 128, 130 may include NFC, which allows for secure, close-proximity interactions ideal for contactless payments and data sharing, or Zigbee®, which is designed for low-power, low-data-rate applications commonly used in internet of things (IoT) devices and smart home systems. By incorporating multiple communication stacks, the wireless device 100 may allow each stack to operate independently based on operations of their respective connectivity chipsets 140 (i.e., first connectivity chipset 142, second connectivity chipset 144).

The connectivity chipsets 140 may include one or more connectivity chipsets. Each of these connectivity chipsets may include, among other things, a MAC layer, a physical (PHY) layer, and one or more baseband processors. The MAC layer may be responsible for implementing MAC layer protocols, which can manage how data packets are transmitted and received over the wireless medium. The MAC layer may serve as an intermediary between (i) host driver 116 and/or short-range communication stacks 126 and (ii) lower-level hardware, software, or firmware (e.g., the host driver 116). The MAC layer may translate high-level data from the into formatted frames suitable for wireless transmission. The MAC layer may handle tasks such as frame assembly and disassembly, addressing, error detection and correction, and may control access to the communication medium to prevent collisions and optimize data flow. Before transmitting data, the MAC layer may encapsulate this data into frames with appropriate headers and trailers before passing them to the PHY layer for transmission. On the other hand, the MAC layer may receive incoming frames from the physical layer, decapsulate them, and forward the extracted data to the application layer 112 (i.e., via the host driver 116 or short-range communication stacks 126) for processing.

The PHY layer may manage tasks such as modulation, encoding for error correction, and/or various signal processing functions. During transmission, the PHY layer may prepare the signal for the RF (Radio Frequency) hardware by modulating it to the right frequency, amplifying it, and filtering out unwanted signals. The PHY layer may include a transmit (TX) chain that is capable of performing these processes. The prepared signal may be transmitted through a TX antenna, which broadcasts the prepared signal into the environment. The antenna may be designed to support specific frequency bands and may include multiple antennas (e.g., for MIMO) to increase data capacity and reliability. On the receiving end, a receive (RX) chain of the PHY layer starts with the antenna capturing incoming electromagnetic signals via an RX antenna. These signals are filtered, amplified, and converted down to a baseband signal, where the baseband signal may be processed using components of the PHY layer. The RX chain and TX chain may share at least some components of the PHY layer, including but not limited to a shared antenna (e.g., the TX antenna and RX antenna may be a same antenna). The received signals can go through decoding and error correction, allowing the PHY layer to recover the transmitted data accurately.

The one or more baseband processors may orchestrate operations of the connectivity chipset. For example, once received signals have been downconverted into a baseband signal, the one or more baseband processors may cause the baseband signal to be sampled (e.g., via an analog-to-digital converter (ADC)) and digitized. The one or more baseband processors may perform decoding and/or error correction operations using the digitized baseband signal. During signal transmission, the one or more baseband processors may receive digital data from higher layers, such as the MAC layer or the host processor 110. The one or more baseband processors may perform signal processing tasks, including encoding, modulation, and scrambling, to prepare the data for transmission over the air. This can involve applying error correction codes, mapping data symbols according to modulation schemes, and organizing the data into frames suitable for the physical medium. Once processed, the baseband processor may forward the formatted signal to the radio frequency (RF) front-end (e.g., the PHY layer), where it is converted into analog signals, amplified, and transmitted via the antenna.

When receiving signals, the one or more baseband processors may operate in the reverse manner. The one or more baseband processors can take analog signals captured by the antenna and converted to digital form. The one or more baseband processors can then perform demodulation, decoding, and error correction to extract the original transmitted data. This can include tasks like synchronizing with the transmitter's timing, equalizing the signal to mitigate channel effects, and de-mapping the received symbols back into bits.

Beyond signal transmission and reception, baseband processors can facilitate intercommunication between multiple connectivity chipsets (e.g., between first connectivity chipset 142 and second connectivity chipset 144) within the wireless device 100. This intercommunication can help coordinate operations between the different connectivity chipsets and help ensure efficient coexistence among different wireless technologies (or APs of different frequency bands) that may operate simultaneously. In some embodiments, this intercommunication may be achieved using GCI bits, which may be dedicated signals or protocols used for exchanging control information between chipsets. By using GCI bits, baseband processors can share status updates, coordinate timing, and manage access to shared resources, such as the RF spectrum. For example, in scenarios where the operations of the network scan logic 124 are at least partially performed by the first connectivity chipset 142 and/or second connectivity chipset 144, GCI bits can allow the connectivity chipsets share information about detected networks or to share status updates about respective network scans. Additionally, these GCI bits may be used to sends commands between the different connectivity chipsets 142, 144.

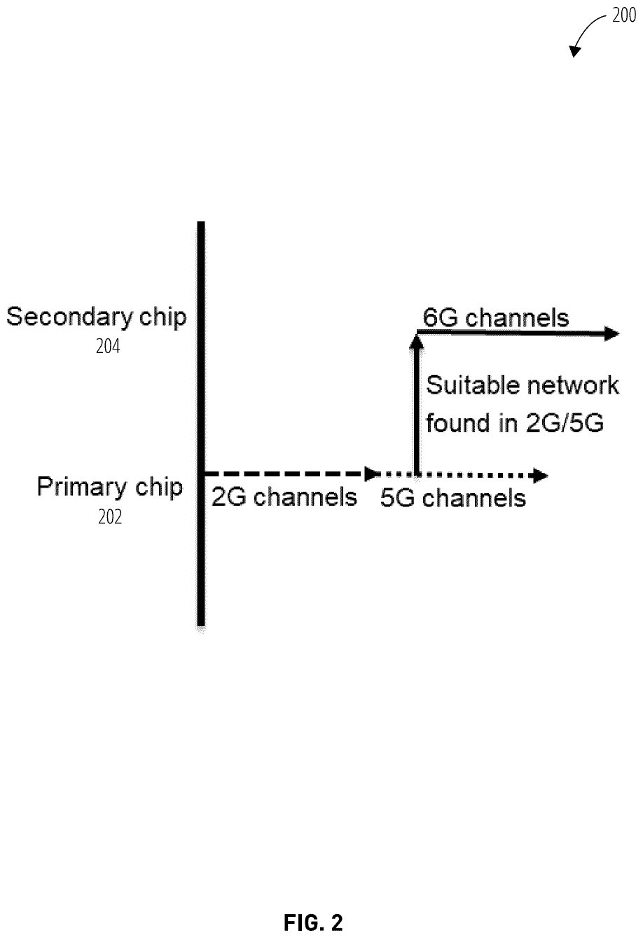

FIG. 2 is a graph 200 illustrating an exemplary implementation of operations of the network scan logic 124, according to one embodiment. Some or all of the operations of the network scan logic 124 may correspond to the illustrated graph 200. As illustrated, the graph 200 shows operations of a primary connectivity chip 202 and a secondary connectivity chip 204. The primary connectivity chip 202 may include one or more features of the first connectivity chipset 142 while the secondary connectivity chip 204 may include one or more features of the second connectivity chipset 144, as described above with respect to FIG. 1. The primary connectivity chip 202 may include one or more features of the first driver 120, and the secondary connectivity chip 204 may include one or more features of the second driver 122. Conversely, the primary connectivity chip 202 may correspond to the second connectivity chipset 144 (and/or second driver 122) while the secondary connectivity chip 204 may correspond to the first connectivity chipset 142 (and/or first driver 120). Operations discussed in relation to the illustrated graph 200 may be performed by the network scan logic 124.

Initially, the primary connectivity chip 202 may perform a first network scan. This first network scan may include detecting networks that support the 2.4 GHz frequency band or 5 GHz frequency band. To support one of these frequency bands, detected network may have a corresponding AP supporting the respective frequency band. This first network scan may be performed as described above. Upon the network scan logic 124 selecting the first network, an indication that the first network was selected may be sent from the primary connectivity chip 202 to the secondary connectivity chip 204. This indication may be sent from the first driver 120 to the second driver 122, or vice versa. In another embodiment, this indication may be sent from the first connectivity chipset 142 directly to the second connectivity chipset 144 via GCI bits, or vice versa. This indication may cause the secondary connectivity chip 204 to search for a 6 GHz AP corresponding to the first network. This 6 GHz AP may be collocated with a 2.4 GHz or 5 GHz AP corresponding to the first network.

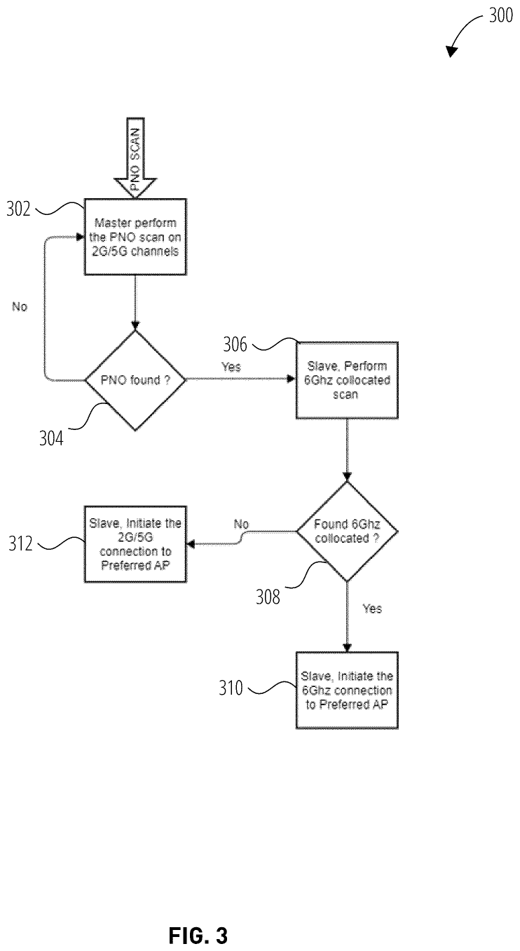

FIG. 3 is a flowchart illustrating a method 300 of initiating a connection to a network, according to one embodiment. The method 300 may be performed by processing logic that may comprise hardware (e.g., circuitry, dedicated logic, programmable logic, microcode, etc.), software (e.g., instructions run on a processing device to perform hardware simulation), firmware, or a combination thereof. In at least one embodiment, the processing logic may refer to one or more portions of a wireless device, such as one or more drivers, a MAC layer, a PHY layer, and/or one or more processors (e.g., the host processor 110). According to embodiments, the processing logic may refer to one or more processing devices of a wireless device. The processing logic may include one or more processing devices and a memory storing instructions that, when executed by the one or more processing devices, perform the method 300. One or more operations of the method 300 may be performed by the network scan logic 124, as described herein. In at least one embodiment, the processing logic includes the network scan logic 124. The method 300 can be performed at least partially by other devices described herein.

At block 302, the processing logic may cause a primary connectivity chip, such as the primary connectivity chip 202 (or one of the connectivity chipsets 140), to perform a first network scan over the 2.4 GHz and 5 GHz frequency bands. This first network scan may include one or more of the features described with respect to network scans herein. In some embodiments, this first network scan may be a preferred network offload (PNO) scan.

At decision block 304, the processing logic may determine whether a suitable network was found by the first network scan. Here, this suitable network may be any network detected by the first network scan that has one or more corresponding metrics that satisfy respective threshold(s). These metrics and thresholds may be as described herein. In some cases, this suitable network may be defined as a detected network to which the wireless device 100 can establish and maintain a connection. In at least one embodiment, the processing logic may determine a network suitable if the wireless device 100 has previously been connected to the network. If the processing logic has not found a suitable network, the processing logic may repeat the first network scan over one or more of the 2.4 GHz and 5 GHz frequency bands. If the processing logic finds a suitable network, the processing logic may cause a second network scan to be performed at block 306.

At block 306, the processing logic may perform a second network scan. This may be performed by a secondary connectivity chip, such as secondary connectivity chip 204 (or one of the connectivity chipsets 140). This second network scan may scan over the 6 GHz frequency band. The second network scan may include one or more of the features described with respect to network scans herein. According to embodiments, the second network scan may scan for a 6 GHz AP collocated with the 5 GHz AP or 2.4 GHz AP found in the first network scan. In other words, the second network scan may search for a 6 GHz AP that belongs to the same suitable network identified or otherwise determined during the first network scan.

At decision block 308, the processing logic may determine whether this 6 GHZ AP was found. If so, the processing logic may cause the secondary connectivity chip to initiate a connection to the 6 GHz AP at block 310. If not, the processing logic may cause the secondary connectivity chip to initiate a connection with the AP found during the first network scan (i.e., a 2.4 GHz AP or a 5 GHz AP). In at least some embodiments, instead of the secondary connectivity chip initiating the connection to the suitable network, the primary connectivity may initiate the connection to the suitable network.

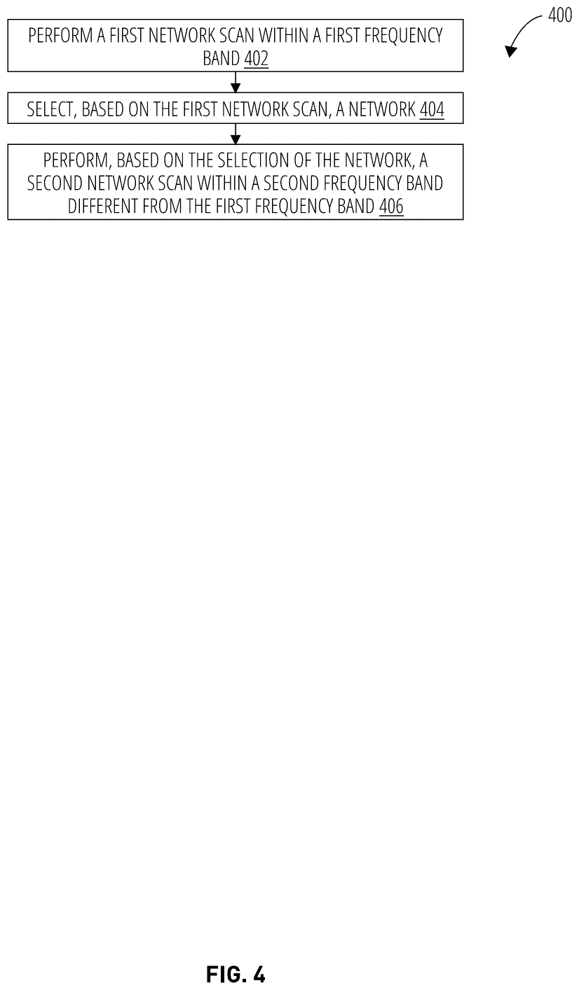

FIG. 4 is a flowchart illustrating a method 400 of performing network scans, according to one embodiment. The method 400 may be performed by processing logic that may comprise hardware (e.g., circuitry, dedicated logic, programmable logic, microcode, etc.), software (e.g., instructions run on a processing device to perform hardware simulation), firmware, or a combination thereof. In at least one embodiment, the processing logic may refer to one or more portions of a wireless device, such as one or more drivers, a MAC layer, a PHY layer, and/or one or more processors (e.g., the host processor 110). According to embodiments, the processing logic may refer to one or more processing devices of a wireless device. The processing logic may include one or more processing devices and a memory storing instructions that, when executed by the one or more processing devices, perform the method 400. One or more operations of the method 400 may be performed by the network scan logic 124, as described herein. In at least one embodiment, the processing logic includes the network scan logic 124. The method 400 can be performed at least partially by other devices described herein.

At block 402, the processing logic may perform a first network scan within a first frequency band. During the first network scan, the processing logic may identify a first AP within one of the 2.4 GHz or 5 GHz frequency bands. This first AP may belong to a network that is identified during the first network scan.

At block 404, the processing logic may select the network. In some embodiments, the network may be selected based on a determination that a first metric corresponding to the first AP satisfies a first threshold. According to embodiments, the network may be selected if a wireless device upon which the processing logic is disposed has previously connected to the network (i.e., the network is known to the wireless device).

At block 406, the processing logic may perform a second network scan within a second frequency band different from the first frequency band. The second network scan may be performed based on the selection of the network. In some embodiments, the second network scan may only be performed if the first network scan identifies a suitable network (i.e., a network that can be selected). In other words, the second network scan may be performed responsive to selecting the network. In at least some embodiments, the second network scan is to detect a second AP that is part of the selected network. The second AP may operate within the 6 GHz frequency band. As part of the second network scan, the processing logic may obtain a second metric corresponding to the second AP. In the event that the second metric satisfies a second threshold, the processing logic may initiate a connection with the second AP within the 6 GHz frequency band. In the event that the second metric does not satisfy the second threshold, the processing logic may initiate a connection with the first AP within one of the 2.4 GHz or 5 GHz frequency bands.

In the above description, numerous details are set forth. It will be apparent, however, to one of ordinary skill in the art having the benefit of this disclosure, that embodiments of the present disclosure may be practiced without these specific details. In some instances, well-known structures and devices are shown in block diagram form, rather than in detail, in order to avoid obscuring the description. Additionally, in the above description, reference is made to the accompanying figures which form a part hereof, and in which is shown, by way of illustration, several embodiments of the present disclosure. It is understood that other embodiments may be utilized and structural changes may be made without departing from the scope of the present disclosure.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “adjusting,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example’ or “exemplary” is not necessarily to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “some embodiments” throughout is not intended to mean the same embodiment or embodiments unless described as such.

Embodiments described herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMS, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store one or more sets of instructions. The term “computer-readable medium” shall also be taken to include any medium capable of storing, encoding, or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, and any medium that is capable of storing a set of instructions for execution by the machine and that causes the machine to perform any one or more of the methodologies of the present embodiments.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid unnecessarily obscuring the present disclosure. Thus, the specific details set forth above are merely exemplary. Particular embodiments may vary from these exemplary details and still be contemplated to be within the scope of the present disclosure.

It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

In the above description, for purposes of explanation, numerous specific details are set forth in order to provide a thorough understanding of the present disclosure. It will be evident, however, to one skilled in the art that the present disclosure may be practiced without these specific details. In other instances, well-known circuits, structures, and techniques are not shown in detail, but rather in a block diagram in order to avoid unnecessarily obscuring an understanding of this description.

Reference in the description to “one embodiment,” “an embodiment,” or “some embodiments” means that a particular feature, structure, or characteristic described in connection with the embodiment(s) is included in at least one embodiment of the disclosure. The phrase “in one embodiment” or “in some embodiments” located in various places in this description does not necessarily refer to the same embodiment(s).

What is claimed is:

1. A method comprising:
performing a first network scan within a first frequency band;
selecting a network identified during the first network scan; and
performing, responsive to selecting the network, a second network scan within a second frequency band different from the first frequency band.

2. The method of claim 1, wherein the first network scan detects a first AP of the network, and wherein the method further comprises:
detecting, via the second network scan, a second AP;
determining that the second AP is of the network; and
initiating a connection to the second AP.

3. The method of claim 2, wherein the second frequency band is higher than the first frequency band.

4. The method of claim 1, further comprising:
obtaining, via the first network scan, a first metric corresponding to a first access point (AP) corresponding to the network; and
responsive to a determination that that the first metric satisfies a first threshold, obtaining, via the second network scan, a second metric corresponding to a second AP corresponding to the network.

5. The method of claim 3, further comprising:
responsive to a determination that the second metric satisfies a second threshold, initiating a connection to the second AP.

6. The method of claim 3, further comprising:
responsive to a determination that the second metric does not satisfy a second threshold, initiating a connection to the first AP.

7. The method of claim 1, wherein the first network scan is performed by a first connectivity chipset, and wherein the second network scan is performed by a second connectivity chipset different from the first connectivity chipset.

8. A wireless device comprising:
one or more processors; and
a memory storing instructions that, when executed by the one or more processors, configure the wireless device to:
perform a first network scan within a first frequency band;
select a network identified during the first network scan; and
perform, responsive to selecting the network, a second network scan within a second frequency band different from the first frequency band.

9. The wireless device of claim 8, wherein the first network scan detects a first AP of the network, and wherein the instructions further configure the wireless device to:
detect, via the second network scan, a second AP;
determine that the second AP is of the network; and
initiate a connection to the second AP.

10. The wireless device of claim 8, wherein the instructions further configure the wireless device to:
obtain, via the first network scan, a first metric corresponding to a first access point (AP) corresponding to the network; and
responsive to a determination that that the first metric satisfies a first threshold, obtain, via the second network scan, a second metric corresponding to a second AP corresponding to the network.

11. The wireless device of claim 10, wherein the instructions further configure the wireless device to:
responsive to a determination that the second metric satisfies a second threshold, initiate a connection to the second AP.

12. The wireless device of claim 10, wherein the instructions further configure the wireless device to:
responsive to a determination that the second metric does not satisfy a second threshold, initiate a connection to the first AP.

13. The wireless device of claim 8, wherein the wireless device comprises a first connectivity chipset and a second connectivity chipset, and wherein the first network scan is performed by the first connectivity chipset and the second network scan is performed by the second connectivity chipset.

14. The wireless device of claim 8, wherein the second frequency band is higher than the first frequency band.

15. A wireless device comprising:
a first connectivity chipset;
a second connectivity chipset different from the first connectivity chipset;
one or more processing devices; and
a memory storing instructions that, when executed by the one or more processing devices, configure the wireless device to:
perform a first network scan via the first connectivity chipset within a first frequency band;
select a network identified during the first network scan; and
perform, responsive to selecting the network, a second network scan via the second connectivity chipset within a second frequency band different from the first frequency band.

16. The wireless device of claim 15, wherein the first network scan detects a first AP of the network, and wherein the instructions further configure the wireless device to:
detecting, via the second network scan, a second AP;
determining that the second AP is of the network; and
initiating a connection to the second AP.

17. The wireless device of claim 15, wherein the instructions further configure the wireless device to:
obtain, via the first network scan, a first metric corresponding to a first access point (AP) corresponding to the network; and
responsive to a determination that that the first metric satisfies a first threshold, obtain, via the second network scan, a second metric corresponding to a second AP corresponding to the network.

18. The wireless device of claim 17, wherein the instructions further configure the wireless device to:
responsive to a determination that the second metric satisfies a second threshold, initiate a connection to the second AP.

19. The wireless device of claim 17, wherein the instructions further configure the wireless device to:
responsive to a determination that the second metric does not satisfy a second threshold, initiate a connection to the first AP.

20. The wireless device of claim 15, wherein the second frequency band is higher than the first frequency band.
